(19) United States
(12) Patent Application Publication
(10) Pub. No.: US 2011/0297521 A1
(43) Pub. Date: Dec. 8, 2011

(54) SHEET SWITCH MODULE AND METHOD OF MANUFACTURING THE SAME

(75) Inventors: Kenji NISHIWAKI, Sakura-shi (JP); Shimpei SATO, Sakura-shi (JP)

(73) Assignee: FUJIKURA LTD., Tokyo (JP)

(21) Appl. No.: 13/210,088

(22) Filed: Aug. 15, 2011

Related U.S. Application Data
(63) Continuation of application No. PCT/JP2010/000957, filed on Feb. 16, 2010.

(30) Foreign Application Priority Data
Feb. 16, 2009 (JP) 2009-032924
Mar. 27, 2009 (JP) 2009-079878

(51) Int. Cl. H01H 9/00; H01H 11/00

(52) U.S. Cl. 200/310; 156/253

(57) ABSTRACT

A sheet switch module of the present invention includes a light source; a light guide having a first end-face on which light emitted from the light source is incident, the light guide guiding the light in at least the thickness direction thereof; a sheet switch disposed on the back side of the light guide in the thickness direction of the light guide; and a light shielding member disposed at a distance from a second end-face different from the first end-face of the light guide.

### CROSS REFERENCE TO RELATED APPLICATIONS

This application is a continuation application based on a PCT Patent Application No. PCT/JP2010/000957, filed Feb. 16, 2010, whose priority is claimed on Japanese Patent Application Nos. 2009-032924, filed on Feb. 16, 2009, and 2009-079878, filed on Mar. 27, 2009, the entire content of which are hereby incorporated by reference.

### BACKGROUND OF THE INVENTION

1. Field of the Invention

The present invention relates to a sheet switch module which is suitably used in illumination of operation buttons and key buttons of cellular phones, personal digital assistants (PDAs), personal computers, and the like.

2. Description of the Related Art

When operation buttons and key buttons of cellular phones, PDAs, personal computers and the like are operated in a dark place, the buttons or keys are illuminated in order to make the position of the buttons or keys visible.

Conventionally, planar light-emitting devices are used in order to brightly illuminate key buttons of a cellular phone, and planar light-emitting devices of the side light-emitting type are widely used as an aspect of the planar light-emitting devices.

The planar light-emitting device of the side light-emitting type is constituted by a light guide film (light guide plate) placed on the back side of a liquid crystal panel which is a display section, and a light source placed on the end side of the light guide film.

In addition, as a light source applied to the planar light-emitting device, there are an LED (Light Emitting Diode), a cold-cathode tube, and the like.

As an example of such an illumination device, a push-button switch type illumination device is disclosed (for example, Japanese Unexamined Patent Application, First Publication No. 2001-167655).

The push-button switch type illumination device is constituted by a plurality of operation keys, a switching element, placed below these operation keys, that perform switching by the press of the operation key, and a flexible light guide plate placed between the operation key and the switching element.

The flexible light guide plate projects light incident from a light source placed on the lateral side toward the lower surface of the operation key to illuminate the operation key from the lower side.

In recent years, it has been desired to illuminate the operation key so as to selectively light up only a specific operation key or not to selectively light up only a specific operation key.

As a method for realizing this, a method of providing a light shielding portion, made of a non-light-transmissive resin, in a light guide is disclosed (refer to, for example, Japanese Unexamined Patent Application, First Publication No. 2008-41431).

That is, in the above-described method, the light shielding portion is provided in the boundary of each region of the light guide by dividing the light guide into a plurality of regions, providing a slit in the portion serving as the boundary of each region, and filling a non-light-transmissive resin in the inside of the slit.

In addition, a push button illumination device is disclosed in which the upper portion and the lower portion of the push button can be respectively illuminated using only one light guiding body (for example, Japanese Examined Utility Model Application, First Publication No. H5-53070).

Such an illumination device includes a light shielding rib having a notch portion and a light guiding body attached to the light shielding rib.

Among them, the light guiding body includes a first light guiding portion and a second light guiding portion that illuminate the upper portion and the lower portion, respectively, of the push button, and the first and second light guiding portions are integrated through a crank-shaped connection.

The light guiding body is attached to the light shielding rib by fitting the crank-shaped connection to the notch portion of the light shielding rib.

As shown in paragraphs 0034 to 0035 and FIG. 5 of Japanese Unexamined Patent Application, First Publication No. 2008-41431, after the light guide is produced by a spin coating method, the slit is produced in this light guide by etching.

Thereafter, a non-light-transmissive liquid resin is filled into this slit, and the light shielding portion is formed by curing the resin.

Therefore, according to the method of Japanese Unexamined Patent Application, First Publication No. 2008-41431, there has been a problem in that production is extremely complicated.

In addition, as shown in paragraphs 0036 to 0037 and FIG. 6 of Japanese Unexamined Patent Application, First Publication No. 2008-41431, even when an insert molding technique is applied, there has been a problem in that since a black hard resin is interposed between molds and a light guide material is poured from both sides, production is extremely complicated.

In addition, the method disclosed in Japanese Unexamined Patent Application, First Publication No. 2008-41431 is a method of providing a light shielding body in the light guide on the operation key side, and the light shielding body has a thickness of 0.3 mm to 2 mm and is very thick.

Furthermore, as shown in FIGS. 5 and 6 of Japanese Unexamined Patent Application, First Publication No. 2008-41431, the light shielding body and the light guide which are integrally molded are completely adhered to each other.

Therefore, the material constituting the light shielding body and the material constituting the light guide are different from each other, there is a possibility that the light shielding body may be peeled off by a change in the environmental temperature due to the difference of the linear expansion coefficients of these materials.

In addition, it is considered that a light shielding member is provided in the push-button switch type illumination device of Japanese Unexamined Patent Application, First Publication No. 2001-167655 by applying the technique of Japanese Examined Utility Model Application, First Publication No. H5-53070.

In this case, as shown in FIG. 4 of Japanese Examined Utility Model Application, First Publication No. H5-53070, since the height of the light shielding rib is lower than that of the light guiding body, the light shielding property is insufficient. Therefore, the push button and an escutcheon (base of the attachment portion) having a height higher than that of the light guiding body have a function of the light shielding.

That is, the light shielding body having a height higher than that of the light guiding body is provided.

However, the field of application of the technique of Japanese Examined Utility Model Application, First Publication No. H5-53070 is a car audio, and it is often the case that there is enough space.

On the other hand, in the field of a cellular phone, it is desired to reduce the thickness thereof insofar as possible, and it is not considered that a member thicker than the light guide plate is provided.

Therefore, the method disclosed in Japanese Unexamined Patent Application, First Publication No. 2008-41431 has been conventionally adopted.

In addition, the light shielding rib shown in Japanese Examined Utility Model Application, First Publication No. H5-53070 is formed integrally with an escutcheon and the like.

When such a technique is applied to a cellular phone, the light shielding body is molded integrally with a switching element placed below the light guide.

For this reason, it is necessary to form a very specific shape, and thus the manufacturing costs are increased.

In addition, in the conventional push-button switch type illumination device, although the light source is closely placed on one end side of the light guide plate, nothing is disposed on the other end side of the light guide plate.

For this reason, there has been a problem in that a portion of light propagating through the inside of the light guide plate leaks from the other end-face of the light guide plate to the outside.

In addition, there has been a problem in that light leaking from the other end-face of the light guide plate reaches the inner surface of a case that receives a push-button switch, and thus the leaking light is visible to a user from the outer side of the case.

The present invention is contrived in view of such circumstances, and an object thereof is to provide a sheet switch module which is capable of selectively lighting up only a specific operation key or of not selectively lighting up the key, using a simple structure.

Furthermore, another object of the present invention is to provide a sheet switch module and a method of manufacturing the same which are capable of preventing light propagating through the inside of the light guide plate from leaking from the end-face of the light guide plate to the outside and of sufficiently illuminating the operation key using the light propagating through the inside of the light guide plate.

### SUMMARY

The present invention for solving the above-mentioned problems adopts the following configurations.

(1) A sheet switch module according to the present invention includes: a light source; a light guide, having a first end-face on which light emitted from the light source is incident, that guides the light in at least the thickness direction thereof; a sheet switch disposed on the back side of the light guide in the thickness direction of the light guide; and a light shielding member disposed at a distance from a second end-face different from the first end-face of the light guide.
(2) A configuration may be adopted in which the light guide includes a plurality of regions divided by a through hole penetrating therethrough in the thickness direction, and the light shielding member is disposed in the through hole at a distance from the end-face of the light guide formed by the through hole.
(3) A configuration may be adopted in which the distance is 0.2 mm to 1 mm.
(4) A configuration may be adopted in which the light shielding member is attached to the surface of the sheet switch with a second adhesive material interposed therebetween, and when the thickness of the light shielding member is represented as α₁, the thickness of the second adhesive material is represented as α₂, and the thickness of the light guide is represented as α₃, the following relational expression (1) is satisfied:

0.8α₃−α₂≦α₁≦2α₃−α₂ (1).

(5) A configuration may be adopted in which the light shielding member is attached to the surface of the sheet switch with an adhesive material interposed therebetween, the regions of the light guide is attached to the surface of the sheet switch with the adhesive material interposed therebetween, and when the thickness of the light shielding member is represented as α₁, the thickness of the adhesive material is represented as α₂, and the thickness of the light guide is represented as α₃, the following relational expression (2) or (3) is satisfied:

α₃≦α₁≦2α₃(α₂≧0.5α₃) (2)

0.8α₃≦α₁≦2α₃(α₂≦0.5α₃) (3).

(6) A configuration may be adopted in which the through hole is a U-shaped through hole, and the light source is placed in each region of the light guide.
(7) A configuration may be adopted in which the light guide is attached to the surface of the sheet switch with a first adhesive material interposed therebetween, the light shielding member is attached to the surface of the sheet switch with a second adhesive material interposed therebetween, and when the thickness of the light shielding member is represented as α₁, the thickness of the second adhesive material is represented as α₂, the thickness of the light guide is represented as α₃, and the thickness of the first adhesive material is represented as α₄, any one of the following relational expressions (4), (5), and (6) is satisfied:

α₃≦α₁≦2α₃(α₂≧0.5α₃; α₂=α₄) (4)

0.8α₃≦α₁≦2α₃(α₂≦0.5α₃; α₂=α₄) (5) and

α₃+α₄≦α₁+α₂≦α₃(α₂≠α₄) (6).

(8) A configuration may be adopted in which the sheet switch module further includes a light shielding sheet that covers at least the light shielding member and the through hole.
(9) A configuration may be adopted in which an operation key is disposed on the surface side of the light guide in the thickness direction of the light guide, and the light shielding member is provided on the surface of the operation key facing the light guide.
(10) A sheet switch module manufacturing method according to the present invention includes the steps of attaching a light guide and a light shielding member on the surface of a sheet switch with an adhesive material interposed therebetween; and forming a gap between the light guide and the light shielding member by simultaneously perforating the light guide and the light shielding member in the thickness direction of the light guide.
(11) A configuration may be adopted in which the attachment step includes attaching the light guide to the surface of the sheet switch with a first adhesive material interposed therebetween, and attaching the light shielding member to the surface of the sheet switch with a second adhesive material interposed therebetween.

According to the sheet switch module of the present invention, in the second end-face of the light guide, the light shielding member is disposed at a distance from this second end-face.

Therefore, when the emission light emitted from the light source is incident on of the first end-face of the light guide, it is possible to light up only the light extraction portion provided on the surface of the light guide using the incident light.

Furthermore, it is possible to prevent (shield) the light which propagates through the inside of the light guide and is emitted from the second end-face of the light guide from leaking to the outside of the sheet switch module.

Therefore, it is possible to sufficiently light up the light extraction portion using the light propagating through the inside of the light guide.

According to the present invention, the light guide is divided into a plurality of regions, the through hole penetrating through the light guide in the thickness direction is provided between these regions, and the light shielding member is disposed within this through hole.

Therefore, it is possible to light up only the light extraction portion provided in a desired region using the light emitted from the light source which is incident on the first end-face of the light guide, using such a simple structure.

Moreover, the light extraction portion provided in another region is not lit up by the incident light.

In addition, the light shielding member is disposed at a distance from the inner side face of the through hole within the through hole of the light guide.

Therefore, when the material constituting the light guide and the material constituting the light shielding member are different from each other, it is possible to prevent the light shielding member from being peeled off by a change of the environmental temperature due to the difference of the linear expansion coefficients of these materials.

Therefore, the range of selections of the material constituting the light guide and the material constituting the light shielding member becomes wide, and the degree of freedom in design of the sheet switch module becomes high.

According to the sheet switch module manufacturing method of the present invention, since the light guide and the light shielding member which are provided on the surface of the sheet switch are simultaneously perforated, when the width of the gap is represented as d4, the width can be 0.2 mm<d4<1 mm, and can be further 0.2 mm<d4<0.4 mm.

Therefore, since the width of the light shielding member can be reduced insofar as possible, it is possible to increase the degree of freedom in design of the sheet switch module.

### BRIEF DESCRIPTION OF THE DRAWINGS

FIG. 1A is a schematic diagram showing a sheet switch module according to a first embodiment of the present invention.

FIG. 1B is a cross-sectional view taken along the A-A line of FIG. 1A.

FIG. 2 is a cross-sectional view showing an example of a sheet switch incorporated in the sheet switch module shown in FIG. 1A.

FIG. 3A is a schematic diagram showing the sheet switch module according to a second embodiment of the present invention.

FIG. 3B is a cross-sectional view taken along the B-B line of FIG. 3A.

FIG. 4A is a schematic diagram showing the sheet switch module according to a third embodiment of the present invention.

FIG. 4B is a cross-sectional view taken along the C-C line of FIG. 4A.

FIG. 5A is a schematic diagram showing the sheet switch module according to a fourth embodiment of the present invention.

FIG. 5B is a cross-sectional view taken along the D-D line of FIG. 5A.

FIG. 6A is a schematic diagram showing a method of manufacturing the sheet switch module according to the present invention.

FIG. 6B is a cross-sectional view taken along the E-E line of FIG. 6A.

FIG. 7A is a schematic diagram showing the method of manufacturing the sheet switch module according to the present invention.

FIG. 7B is a cross-sectional view taken along the F-F line of FIG. 7A.

### DETAILED DESCRIPTION OF THE PREFERRED EMBODIMENTS

Hereinafter, a sheet switch module according to embodiments of the present invention will be described with reference to the drawings.

Additionally, in the description of the present invention, the surface (or upper surface) is indicative of a surface directed to the +Z direction, and the back (or lower surface) is indicative of a surface directed to the −Z direction.

However, the surface or the back is defined for the convenience of the illustration and the description, and the present invention is not limited thereto.

Moreover, the embodiments are specifically described in order to better understand the scope of the present invention, but the present invention is not limited thereto unless particularly specified.

### Sheet Switch Module

### First Embodiment

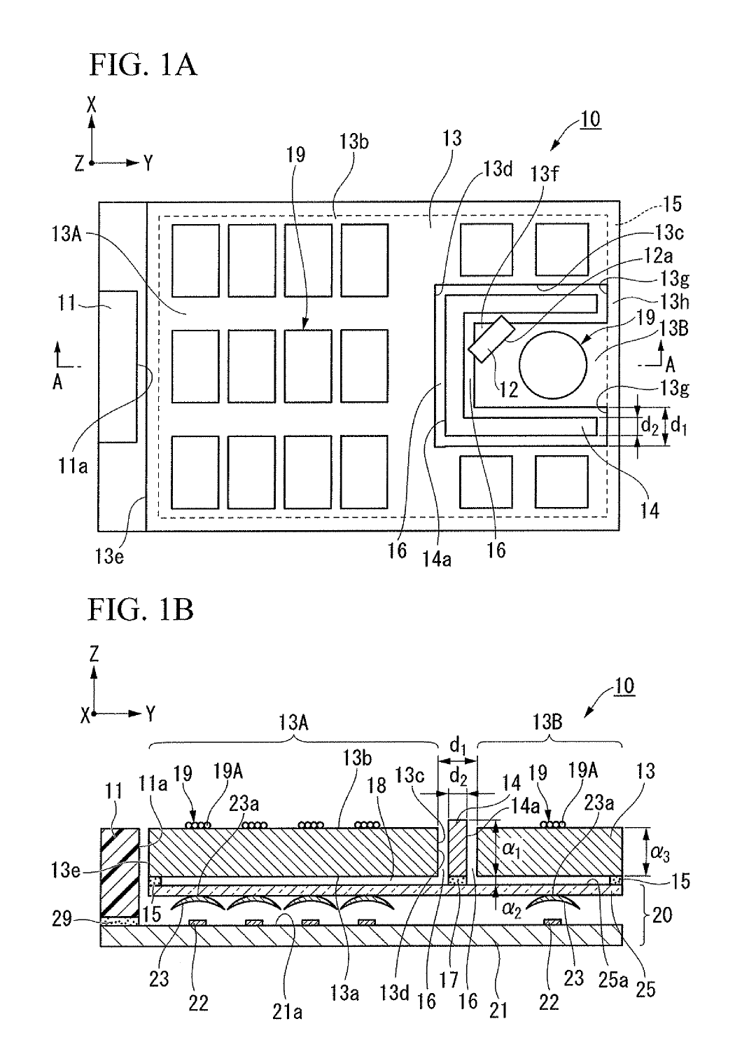

FIG. 1A is a schematic diagram (plan view) showing a sheet switch module according to a first embodiment of the present invention, and FIG. 1B is a cross-sectional view taken along the A-A line of FIG. 1A.

As shown in FIGS. 1A and 1B, a sheet switch module 10 according to the present embodiment includes a first light source 11, a second light source 12, a sheet-shaped light guide 13, and a sheet switch 20 placed at the back (lower surface) 13a side of the light guide 13.

The light guide 13 is formed in a rectangular shape when seen in a plan view (X-Y plane) of FIG. 1A.

Furthermore, as shown in FIGS. 1A and 1B, the light guide 13 is disposed closely to the emission surface 11a of the first light source 11.

Hereinafter, each of the configurations will be described.

<first light source and second light source>

As the first light source 11 and the second light source 12, a light-emitting element such as a light-emitting diode (hereinafter, referred to as an LED) and a light-emitting body such as a cold-cathode tube are used.

When the first light source 11 and the second light source 12 are an LED, they are configured such that a light-emitting element chip is embedded in the inside of a box-shaped case, and light emitted from the light-emitting element chip can be emitted from the emission surface 11a of the first light source 11 or the emission surface 12a of the second light source 12.

In addition, as shown in FIG. 1B, the first light source 11 is provided on the surface (upper surface) 21a of a board 21 by a solder 29.

Similarly, the second light source 12 is provided on the surface (upper surface) 21a of the board 21 by a solder (not shown).

In other cases, a method of connecting the light source to the board is not limited to the solder, but can employ a connection using an adhesive, a mechanical connection, or the like.

In addition, as shown in FIG. 1A, the first light source 11 and the second light source 12 are respectively placed along the Y direction.

That is, the first light source 11 and the second light source 12 are placed in the longitudinal direction light of the guide 13.

However, the placement of the first light source 11 and the second light source 12 is not limited thereto, but can be performed along the lateral direction of the light guide 13, that is, along the X direction (for example, the first light source 11 and the second light source 12 can be respectively installed on both ends of the light guide 13 in the X direction).

In other cases, the second light source 12 is disposed in the position shown in FIG. 1A in order to perform uniform light irradiation, and then two first light sources 11 can be installed on both ends of a second region 13B of the light guide 13 in the X direction.

<Sheet Switch>

The sheet switch 20 adheres to the light guide 13 with a first adhesive material 15 interposed therebetween having a frame shape which is provided in the periphery of the back (lower surface, or one surface) 13a of the light guide 13.

Therefore, a gap 18 is provided between the light guide 13 and the sheet switch 20.

That is, the light guide 13 and the sheet switch 20 are not in contact with each other, and are placed facing each other at a distance corresponding to the thickness of the first adhesive material 15.

In FIGS. 1A and 1B, the first adhesive material 15 is provided along the outer circumference of the light guide 13, in a rectangle shape, as shown by the dotted line of FIG. 1A, but is not limited thereto.

Furthermore, in the outer circumference of the second region 13B of the light guide 13, the first adhesive material 15 may be provided along the U-shape.

Additionally, in the outer circumference of a first region 13A of the light guide 13 corresponding to the second region 13B, the first adhesive material 15 may be provided along the U-shape.

It is preferable that these first adhesive materials 15 have the same thickness as each other.

The thickness of the gap 18 provided between the light guide 13 and the sheet switch 20 is not particularly limited.

That is, in the state where the sheet switch module 10 is used, when the light guide 13 and the sheet switch 20 are not in contact with each other, the distance between the light guide 13 and the sheet switch 20 is not particularly limited.

It is preferable that the above-mentioned distance is 0.01 mm to 0.05 mm in order to reduce the thickness of the sheet switch module 10.

Hereinafter, a detailed structure of the sheet switch 20 will be described.

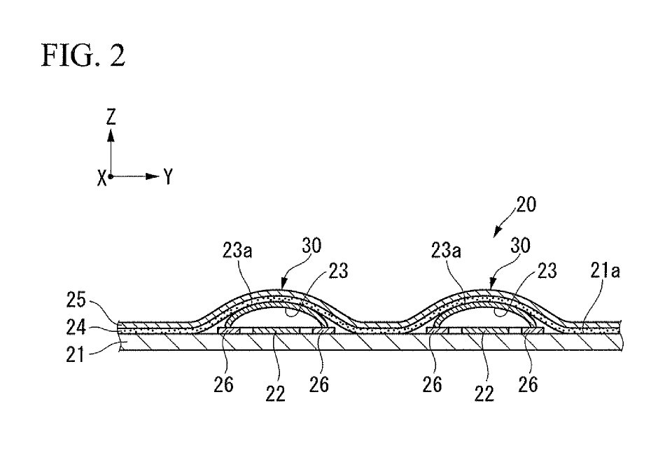

As shown in FIG. 2, the sheet switch 20 includes the board 21, a plurality of contact portions 22 provided on the surface (upper surface, or one surface) 21a of the board 21, annular contact portions 26 provided in the periphery of the contact portions 22, dome-shaped metal plates 23 that cover the contact portions 22 and the contact portions 26, and a press sheet 25 that covers the metal plates 23.

In addition, the press sheet 25 covers the metal plate 23 with an adhesive layer 24 interposed therebetween, and maintains the position of the metal plate 23.

In other words, as shown in FIG. 2, one pressure-sensitive switch element 30 is constituted by the contact portion 22, the annular contact portion 26, the metal plate 23, and the press sheet 25.

A plurality of switch element 30 is provided on the surface 21a of the board 21, to form the sheet switch 20.

The board 21 is formed of a printed circuit board such as a PCB (Printed Circuit Board) or an FPC (Flexible Printed Circuit).

The plurality of contact portions 22 is provided at a predetermined distance in the surface 21a (X-Y plane) of the board 21, and this predetermined distance can be set in accordance with the placement position and the dimensions of key buttons to be illuminated.

In other cases, the plurality of contact portions 22 and the plurality of annular contact portions 26 are made of conductive materials, and can be respectively formed of the same or different conductive material without being particularly limited as long as the materials are conductible to each other.

The metal plate 23 has flexibility to be attachable and detachable to and from the contact portion 22, and forms a convex bowl-shaped metal dome on the side opposite to of the surface 21a of the board 21.

That is, the metal plate 23 is an arch-shaped flexible plate protruding in the +Z direction when seen in a cross-sectional view of FIG. 2, and is curved in the −Z direction by external force. The metal plate can be restored to the original state by its flexibility when the external force is eliminated.

More specifically, for example, when an operator presses the metal plate 23 in the −Z direction (direction from top to bottom in FIG. 2) using an operating tool such as fingers, the central portion of the metal plate 23 is curved toward the surface 21a side of the board 21, and thus it can abut on the contact portion 22.

That is, the metal plate 23 and the contact portion 22 are in contact with each other by pressing the central portion of the surface 23a of the metal plate 23, thereby allowing the contact portion 22 and the contact portion 26 to be electrically conducted to each other by the contact.

Additionally, when external force applied by an operator is eliminated, the metal plate 23 is restored to its original state by its flexibility, and the metal plate 23 and the contact portion 22 are converted from the contact state to the non-contact state. Thus, the contact portion 22 and the contact portion 26 are electrically non-conducted to each other.

In this manner, it is possible to switch the conduction and non-conduction of the contact portion 22 to the contact portion 26 by the contact and non-contact of the metal plate 23 with the contact portion 22.

Among them, the surface 23a of the metal plate 23 is a surface on the side opposite to the surface facing of the surface 21a of the board 21, that is, a surface directed to the +Z direction.

<Light Guide>

In the present embodiment, the light guide 13 includes the first region 13A and the second region 13B.

In addition, as shown in FIG. 1A, a through hole 13c formed in a U-shape in the X-Y plane (when seen in a plan view) is formed between the first region 13A and the second region 13B.

As shown in FIG. 1B, the through hole 13c penetrates through the light guide 13 in the thickness direction (Z direction).

That is, the light guide 13 is divided into two regions by the through hole 13c.

In the following description, the end on the first light source 11 side of the light guide 13 is represented as a first end, and the end on the second light source 12 side thereof is represented as a second end.

In the present embodiment, the through hole 13c is formed at the second end side of the light guide 13 in the Y direction, that is, at the side opposite to the side provided with the first light source 11.

In addition, the through hole 13c is formed at the central side of the light guide 13 in the X direction.

Both ends 13g of the U-shaped through hole 13c are placed in close proximity to the end edge of the light guide 13.

In addition, the first region 13A and the second region 13B are connected to each other by a bridge portion 13h adjacent to both ends 13g of the U-shaped through hole 13c.

The width in the bridge portion 13h in the Y direction is the same level as the width of the first adhesive material 15, described below, in the Y direction.

Consequently, diversion of light through this portion is suppressed to a minimum.

In addition, the second light source 12 is disposed on one end 13f of the second region 13B of the light guide 13, and the second light source 12 causes light to be incident on the second region 1313.

Additionally, as shown in FIGS. 1A and 1B, a light shielding member 14 having a U-shape when seen in a plan view is disposed in the inside of the through hole 13c at a distance from the inner periphery 13d of the through hole 13c.

Accordingly, a gap 16 is provided between the inner periphery 13d of the through hole 13c and the outer periphery 14a of the light shielding member 14.

Furthermore, the light shielding member 14 adheres to the surface of the sheet switch 20 facing the light guide 13 with a second adhesive material 17 interposed therebetween.

That is, the light shielding member 14 adheres to the surface (upper surface) 25a of the press sheet 25 constituting the sheet switch 20 with the second adhesive material 17 interposed therebetween.

In FIG. 1B, only a portion of the configuration of the sheet switch 20 shown in FIG. 2 is shown.

<Light Shielding Member, and Relationship of Width Between Through Hole And Light Shielding Member>

The width d1 of the through hole 13c can be appropriately adjusted in accordance with the width d2 of the light shielding member 14.

That is, as long as the light shielding member 14 is not in contact with the inner periphery 13d of the through hole 13c and can be placed upright with the through hole 13c with the second adhesive material 17 interposed therebetween, the width d1 of the through hole 13c is not particularly limited.

The width d1 of the through hole 13c is preferably 1.0 mm to 1.8 mm, and more preferably 1.0 mm to 1.4 mm.

When the width d1 of the through hole 13c is less than 1.0 mm, the width d2 of the light shielding member 14 placed within the through hole 13c becomes excessively small, and thus the light shielding member 14 is not easily placed upright within the through hole 13c with the second adhesive material 17 interposed therebetween.

On the other hand, when the width d1 of the through hole 13c exceeds 1.8 mm, the occupancy ratio of the through hole 13c to the light guide 13 become excessively large, resulting in the interference with the light-emitting area, and thus the present structure cannot be applied as a product.

Additionally, in the present embodiment, the widths in the X direction and the Y direction of the through hole 13c are the same as each other.

However, the through hole 13c can have a different width in the X direction and the Y direction, depending on the type and the installation direction or the like of the light source.

That is, as long as the light can be prevented from leaking by the light shielding member 14 installed in the inside of the through hole 13c, the width thereof is not particularly limited.

The width d2 of the light shielding member 14 is not particularly limited when the light shielding member 14 is not in contact with the inner periphery 13d of the through hole 13c and can be placed upright within the through hole 13c with the second adhesive material 17 interposed therebetween.

The width d2 of the light shielding member 14 is appropriately adjusted in accordance with the width d1 of the through hole 13c, but the width is preferably 0.5 mm to 1.4 mm, and more preferably 1.0 mm to 1.2 mm.

When the width d2 of the light shielding member 14 is less than 0.5 mm, the light shielding member 14 is not easily placed upright with the through hole 13c with the second adhesive material 17 interposed therebetween.

On the other hand, when the width d2 of the light shielding member 14 exceeds 1.4 mm, the occupancy ratio of the through hole 13c that receives and places the light shielding member 14 to the light guide 13 becomes excessively large, resulting in the interference with the light-emitting area, and thus the present structure cannot be applied as a product.

The width of the gap 16 between the through hole 13c and the light shielding member 14 can be expressed by (d1-d2)/2.

The width of the gap 16 is not particularly limited, it is preferably 0.2 mm to 1 mm.

That is, it is preferable to satisfy of the relational expression of 0.2 mm≦(d1-d2)/2≦1 mm, and it is more preferable to satisfy the relational expression of 0.2 mm≦(d1-d2)/2≦0.4 mm.

Moreover, the width of the gap 16 is preferably a range which does not exceed 5 mm.

When the width of the gap 16 is smaller than 0.2 mm, the light guide 13 and the light shielding member 14 is in contact with each other due to the thermal expansion, and thus there is a possibility that drawbacks such as peeling-off of the light shielding member 14 may occur.

As a result, the light leaks from the first region 13A of the light guide 13 to the second region 13B thereof.

The lower limit of the width of the gap 16 can be set depending on the linear expansion coefficient, the manufacturing temperature, the operating temperature, or the like of light guide 13 and the light shielding member 14 which are actually used.

That is, the light guide 13 and the light shielding member 14 can be installed in the range without being in contact with each other due to the thermal expansion.

As an example for calculating the lower limit of the width of the gap 16, for example, the light guide 13 made of a polycarbonate resin of which the linear expansion coefficient is 67 ppm and the length is 50 mm is prepared.

Additionally, the light shielding member 14 made of PET of which the linear expansion coefficient is 80 ppm and the length is 1.4 mm is prepared.

When the manufacturing temperature is 20° C. and the operating temperature of a product is a range of −40° C. to 85° C., as a result of calculating the expansion width (ΔL=α·L·ΔT) in the maximum temperature difference of 65° C., the light guide 13 expands by approximately 0.2 mm, and the light shielding member 14 expands by approximately 0 mm (does not nearly expand).

Therefore, in this case, the lower limit of the width of the gap 16 is 0.2 mm, thereby allowing the light guide 13 and the light shielding member 14 to be prevented from being in contact with each other due to the thermal expansion.

On the other hand, the upper limit of the width of the gap 16 may be a range in which the light emitted from the end-face of the light guide 13 is not reflected by the press sheet 25.

As a result of the test, when the width of the gap 16 is higher than 5 mm, it is confirmed that the light emitted from the light guide 13 is reflected by the press sheet 25.

Therefore, the width of the gap 16 is required to be a range which does not exceed 5 mm.

<Thickness of Light Shielding Member>

Hereinafter, the relationship between the thickness (height) of the light shielding member 14, the thickness of the adhesive material, and the thickness of the light guide 13 will be described.

In the present embodiment, an example of the outer circumference adhesion (FIGS. 1A and 1B) and an example of the whole circumference adhesion (not shown) will be separately described in accordance with the installation range of the first adhesive material 15.

The example of the outer circumference adhesion shows a case in which the first adhesive material 15 is not formed only in the outer circumference of the light guide 13, as shown in FIGS. 1A and 1B.

The example of the whole circumference adhesion shows a case in which the first adhesive material 15 is formed in the whole circumference of the end which includes the outer circumference of the light guide 13 shown in FIGS. 1A and 1B and the U-shaped outer circumference of the first region 13A and the second region 13B facing the through hole 13c.

First, in the example of the outer circumference adhesion shown in FIGS. 1A and 1B, the influence of the relationship between the thickness of the light shielding member 14, the thickness of the second adhesive material 17, and the thickness of the light guide 13 of the light-shielding effect is confirmed by performing a test in the following conditions.

When the thickness (height) of the light shielding member 14 in the Z direction is represented as α₁, the thickness (height) of the second adhesive material 17 is represented as α₂, and the thickness (height) of the light guide 13 is represented as α₃, the light-shielding effect was measured by changing the thicknesses of the light shielding member 14, the second adhesive material 17, and the light guide 13.

The results are shown in the following Table 1 to Table 3.

TABLE 1

| Thickness | | Thickness (α₁) of light shielding member | | | |
|---|---|---|---|---|---|
| 100 μm (α₃) of light guide | | 75 μm | 125 μm | 188 μm | 250 μm |
| Thickness (α₂) | 30 μm | G | G | G | G |
| of second | 60 μm | G | G | G | G |
| adhesive material | 90 μm | G | G | G | G |

TABLE 2

| Thickness | | Thickness (α₁) of light shielding member | | | |
|---|---|---|---|---|---|
| 150 μm (α₃) of light guide | | 75 μm | 125 μm | 188 μm | 250 μm |
| Thickness (α₂) | 30 μm | NG | G | G | G |
| of second | 60 μm | G | G | G | G |
| adhesive material | 90 μm | G | G | G | G |

TABLE 3

| Thickness | | Thickness (α₁) of light shielding member | | | |
|---|---|---|---|---|---|
| 200 μm (α₃) of light guide | | 75 μm | 125 μm | 188 μm | 250 μm |
| Thickness (α₂) | 30 μm | B | NG | G | G |
| of second | 60 μm | B | G | G | G |
| adhesive material | 90 μm | B | G | G | G |

G: The light-shielding effect is sufficient.
NG: The light-shielding effect is insufficient.
B: There is no light-shielding effect.

As can be seen from the above test example, when the thickness (α₁+α₂) of the light shielding member 14 and the second adhesive material 17 reaches 80% of the thickness α₃ of the light guide 13, it is possible to obtain the sufficient light-shielding effect.

In addition, when the thickness (α₁+α₂) of the light shielding member 14 and the second adhesive material 17 exceeds two times the thickness α₃ of the light guide 13, drawbacks may be caused at the time of the combination with another member.

For example, when the application to the key switch portion of a cellular phone is performed, drawbacks such as deterioration of the sense of touch of the switch may be caused.

Furthermore, in the relationship of α₁+α₂>2α₃, the thickness al of the light shielding member 14 becomes excessively large, and thus it is difficult to reduce the thickness of the sheet switch module 10.

Therefore, the thicknesses preferably satisfy the relationship of 0.8α₃≦α₁+α₂≦2α₃, and more preferably satisfy the relationship of α₃<α₁+α₂≦2α₃.

In addition, in the relationship of α₁+α₂≦α₃, the light-shielding effect between the first region 13A and the second region 13B by the light shielding member 14 becomes insufficient and thus the light cannot be completely shielded. Therefore, the entrance and exit of the light between the first region 13A and the second region 13B are performed, and thus it is not possible to light up only a desired region (any of the first region 13A or the second region 13B).

Next, in the example of the whole circumference adhesion (not shown), similarly to the above-mentioned test example, the influence of the relationship between the thickness of the light shielding member 14, the thickness of the second adhesive material 17, and the thickness of the light guide 13 of the light-shielding effect is confirmed by performing a test in the following conditions.

In the present test example, the thicknesses of the first adhesive material 15 and the second adhesive material 17 are the same as each other.

The results are shown in the following Table 4 to Table 6.

TABLE 4

| Thickness | | Thickness (α₁) of light shielding member | | | |
|---|---|---|---|---|---|
| 100 μm (α₃) of light guide | | 75 μm | 125 μm | 188 μm | 250 μm |
| Thickness (α₂) | 30 μm | G | G | G | G |
| of | 60 μm | NG | G | G | G |
| adhesive material | 90 μm | B | G | G | G |

TABLE 5

| Thickness | | Thickness (α₁) of light shielding member | | | |
|---|---|---|---|---|---|
| 150 μm (α₃) of light guide | | 75 μm | 125 μm | 188 μm | 250 μm |
| Thickness (α₂) | 30 μm | B | NG | G | G |
| of | 60 μm | B | NG | G | G |
| adhesive material | 90 μm | B | NG | G | G |

TABLE 6

| Thickness | | thickness (α₁) of light shielding member | | | |
|---|---|---|---|---|---|
| 200 μm (α₃) of light guide | | 75 μm | 125 μm | 188 μm | 250 μm |
| Thickness (α₂) | 30 μm | B | NG | G | G |
| of | 60 μm | B | B | G | G |
| adhesive material | 90 μm | B | B | G | G |

G: The light-shielding effect is sufficient.
NG: The light-shielding effect is insufficient.
B: There is no light-shielding effect.

When the first adhesive material 15 is formed in the whole circumference of the end of the light guide 13, that is, in FIG. 1B, in both sides of the light shielding member 14, when the first adhesive material 15 is also formed between the first region 13A and the sheet switch 20, and between the second region 13B and the sheet switch 20, it is possible to shield the light if the light shielding member 14 is higher than the light guide 13.

However, when the second adhesive material 17 has a certain degree of thickness, there is a possibility that the light may leak through the second adhesive material 17.

Therefore, the thickness α₂ of the second adhesive material 17 is preferably 50% or less of the thickness α₃ of the light guide 13.

Furthermore, when the thickness α₂ of the second adhesive material 17 is 50% or less of the thickness α₃ of the light guide 13, the thickness α₁ of the light shielding member 14 is more preferably 80% or more of the thickness α₃ of the light guide 13, for the purpose of reliable light shielding.

That is, it is preferable to satisfy the relationship of α₃≦α₁≦2α₃ (α₂≧0.5α₃) or 0.8α₃≦α₁≦2α₃ (α₂≦0.5α₃).

In addition, the thickness α₂ of the second adhesive material 17 is not particularly limited when the above-mentioned relationship is satisfied, but it is preferably equal to the thickness of the first adhesive material 15.

When the thickness α₂ of the second adhesive material 17 is equal to the thickness of the first adhesive material 15, it is possible to completely shield the light leaking to the back 13a side of the light guide 13 by the light shielding member 14.

Furthermore, as shown in FIG. 1B, a plurality of light extraction portions 19 is formed in a predetermined position on the surface 13b of the light guide 13.

Here, the surface 13b of the light guide 13 is a surface on the side opposite to the back 13a of the light guide 13.

The surface 13b of the light guide 13 constitutes the upper surface (surface, or light-emitting surface) of the sheet switch module 10.

In addition, as shown in FIG. 1B, a plurality of light extraction portions 19 is installed in accordance with the position of a plurality of pressure-sensitive switch elements 30 of the sheet switch 20.

That is, a plurality of light extraction portions 19 is disposed facing the metal plate 23 of each of the switch elements 30.

<Constituent Material>

The light guide 13 is made of a sheet-shaped resin, and the resin constituting the light guide 13 is not particularly limited as long as it is a light-transmissive resin and an elastically deformable resin.

For example, one type of resin selected from a group consisting of a polyurethane-based resin, a polycarbonate-based resin, a silicon-based resin, a polystyrene-based resin, a polyimide-based resin, elastomer of polymethylmethacrylate (PMMA), and urethane acrylate is used.

Among these resins, in order to constantly maintain the width of gap 18 provided between the light guide 13 and the sheet switch 20, that is, in order for the light guide 13 and the sheet switch 20 not to be in contact with each other, a resin having an adequate rigidity is preferable, and specifically, a polycarbonate-based resin is preferable.

In addition, the polycarbonate-based resin is suitable because the transmittance of the light is high even when its thickness is small.

In addition, since a polyurethane-based resin or a silicon resin has an elasticity, the upper surface of the light guide 13 made of these resins is scarcely damaged, and the sense of touch when the switch element 30 (light extraction portion 19) is pressed is improved.

The thickness of the light guide 13 is not particularly limited. It is not particularly limited as long as the transmittance of the emission light from the first light source 11 and the second light source 12 is high, the light guide can be curved in the Z direction when external force is applied, and the width of the gap 18 between the light guide 13 and the sheet switch 20 can be constantly maintained when the external force is eliminated.

That is, it is preferable that when there is no external force, the light guide 13 and the sheet switch 20 are not in contact with each other, and when an operator presses the light extraction portion 19 using an operating tool such as a fingertip or a pen, the central portion of the metal plate 23 abuts on the contact portion 22 by curving the metal plate 23 downward by this press, thereby allowing the contact portion 22 to be brought into conduction with the contact portion 26.

However, in order to reduce the thickness of the sheet switch module 10, the thickness is preferably 0.1 mm to 0.2 mm.

The material constituting the light shielding member 14 is not particularly limited as long as it is a light shielding material and has such a rigidity that it can erect the light shielding member at the time of placing the light shielding member 14 within the through hole 13c.

As the light shielding member 14, for example, one selected from a group consisting of resins such as a polyurethane-based resin, a polycarbonate-based resin, a silicon-based resin, a polystyrene-based resin, and a polyimide-based resin, and various types of metals is used.

The hue of the light shielding member 14 is not particularly limited as long as it has a sufficient light shielding property, a black color is preferable because it absorbs the light best and has a high light shielding property.

As the first adhesive material 15 and the second adhesive material 17, an adhesive maintaining its own shape is used.

Such an adhesive includes an acrylic resin, a polyurethane resin, an epoxy resin, a urethane resin, a natural rubber-based adhesive, a synthetic rubber-based adhesive, or a double-sided tape that applies these resins or adhesive materials to double sides of the base made of a resin or paper.

In addition, the thicknesses of the first adhesive material 15 and the second adhesive material 17 are not particularly limited. However, in the state where the sheet switch module 10 is used, the thickness of the second adhesive material 17 is preferable when it has such a thickness that the light guide 13 and the sheet switch 20 are not in contact with each other, and is preferably 0.01 mm to 0.05 mm in order to reduce the thickness of the sheet switch module 10.

In addition, as mentioned above, the thickness of the first adhesive material 15 is preferably equal to that of the second adhesive material 17.

<Illumination of Key Button>

The light extraction portion 19 formed on the surface 13b of the light guide 13 includes uneven portion 19A formed in a required region of the surface 13b of the light guide 13 made of a sheet-shaped resin sheet.

The light from the inside of the light guide 13 is emitted to the surface 13b of the light guide 13 in a region in which the uneven portion 19A are formed.

When the emission light from the first light source 11 is incident on a first end-face 13e of the first region 13A of the light guide 13, the incident light is reflected between the back 13a and the surface 13b of the light guide 13, and propagates through the inside of the light guide 13.

Since the uneven portion 19A are formed in the required region of surface 13b of the light guide 13, the light propagating through the inside of the light guide 13 leaks out from the uneven portion 19A.

Because of this, it is possible to emit the light from the light extraction portion 19 of the light guide 13 to the outside.

That is, it is possible to light up the light extraction portion 19 using the light propagating through the inside of the light guide 13.

Similarly, when the emission light from the second light source 12 is incident on one end 13f of second region 13B of the light guide 13, the incident light is reflected between the back 13a and the surface 13b of the light guide 13 and propagates through the inside of the light guide 13.

For this reason, the light propagating through the inside of the light guide 13 can be emitted from the light extraction portion 19 provided on the surface 13b of the light guide 13 to the outside.

<Formation of Light Extraction Portion>

The uneven portion 19A constituting the light extraction portion 19 are extremely small dots formed on the surface 13b of the light guide 13.

These extremely small dots can be formed by printing methods such as a screen printing method, a gravure printing method, and a pad printing method.

The screen printing method is a method, as one type of stencil printing, of using a plate clad with a screen made of a chemical fiber to chemically produce a plate film on the screen, and then closing up membranes other than the required streaks and rubbing ink through holes in the plate film, to thereby perform printing on the printing surface of a substance to be printed which is installed below the plate.

Since the ink is extruded against the surface to be printed and is printed by passing through holes in the plate film of the screen, it is possible to form the uneven portion 19A having the required size.

Since the uneven portion 19A (light extraction portion 19) formed by the screen printing method can be perceived as numerals or characters, it is not necessary to provide operation keys on the surface 13b of the light guide 13.

Consequently, it is possible to considerably reduce the thickness of the sheet switch module 10.

Furthermore, it is possible to considerably reduce the thickness of the electronic device to which the sheet switch module 10 is applied.

In addition, according to the screen printing method, it is possible to form the uneven portion 19A (light extraction portion 19) having the desired hue by adjusting the ink.

Therefore, the sheet switch module 10 can be made more excellent in design.

Also the electronic device to which the sheet switch module 10 is applied can be made more excellent in design.

The gravure printing is a printing method of forming the uneven portion as mentioned below.

That is, using the plate of which a certain protruding portion attempted to be printed is hollowed, ink is applied to the entirety of the plate by an appropriate method so that the ink gets into the hollow.

Thereafter, the surface of the plate is wiped off by a device called a doctor, and then extra ink is scraped off.

Accordingly, only the ink in the hollow is left.

Thereafter, the ink is pushed against the surface to be printed and is transferred, and the uneven portion are formed by forming the swollen portion of the ink.

Since the shading of printing can be limited by the width of the hollow and the thickness of the ink, it is possible to form an exquisite uneven shape and to form the desired uneven portion 19A on the surface 13b of the light guide 13.

The gravure printing method can form extremely small uneven portion 19A compared to the screen printing method.

Therefore, it is possible to form such uneven portion 19A that cannot be perceived at first glance.

In addition, it is possible to form the uneven portion 19A (light extraction portion 19) having the desired hue by adjusting the ink or the printing plate.

Therefore, the sheet switch module 10 can be made more excellent in design.

Furthermore, the electronic device to which the sheet switch module 10 is applied can be made more excellent in design.

The pad printing is a method of forming the uneven portion as mentioned below.

That is, the ink is filled up in the concave portion of an intaglio plate, and the ink of the portion other than the concave portion is scraped away by a blade.

Thereafter, a pad made of silicon and the like is pushed against an intaglio to transfer the ink to the pad.

Thereafter, this pad is pushed against the printing surface of the substance to be printed, thereby allowing the uneven portion to be formed.

In other cases, various shapes such as a spherical shape or a drum shape can be applied to the pad.

According to this method, since a three-dimensional shape can also be accurately transferred, it is possible to form the desired uneven portion 19A on the surface 13b of the light guide 13.

Among these printing methods, the screen printing method has an advantage that the printing plate is more inexpensive than that used in the gravure printing method, and that the degree of accuracy is higher than that in the pad printing method.

In addition, the screen printing method has an advantage that the desired uneven portion can be formed by variously changing the printing plate and the ink, and an advantage that excellent reproducibility and mass production can be obtained.

In the sheet switch module 10 according to the present embodiment, when an operator presses the light extraction portion 19 of the light guide 13 using an operating tool such as a fingertip or a pen, the metal plate 23 is curved downward and deformed by this press.

The central portion of the metal plate 23 abuts on the contact portion 22 by this deformation, thereby allowing the contact portion 22 and the contact portion 26 to be brought into conduction with each other.

Therefore, according to the sheet switch module 10 of the present embodiment, it is possible to display the position of the switch module provided with the metal plate 23 using the light leaking from each of the light extraction portions 19.

Additionally, the light extraction portion 19 is pressed to deform the metal plate 23, whereby it is possible to perform the on/off (conduction and non-conduction) operations of each of the switch elements 30 by switching the conduction of the contact portion 22 and the contact portion 26 with each other.

In the sheet switch module 10 according to the present embodiment, the light guide 13 is divided into the first region 13A and the second region 13B, and the through hole 13c passing through the light guide 13 in the thickness direction is provided between these two regions.

In addition, the light shielding member 14 is disposed in the through hole 13c.

Therefore, when the emission light from the first light source 11 is incident on the first end-face 13e of the first region 13A of the light guide 13, it is possible to light up only the light extraction portion 19 provided in the first region 13A by the incident light.

Furthermore, the light extraction portion 19 provided in the second region 13B is not lit up by the incident light.

In addition, similarly, when the emission light from the second light source 12 is incident on one end 13f of the second region 13B of the light guide 13, it is possible to light up only the light extraction portion 19 provided in the second region 13B by the incident light.

Moreover, the light extraction portion 19 provided in the first region 13A is not lit up by the incident light.

That is, it is possible to selectively light up the first region 13A and the second region 13B of the light guide 13 so that they are respectively lit up or not lit up.

In addition, in the through hole 13c of the light guide 13, the light shielding member 14 is disposed at a distance from the inner periphery 13d of the through hole 13c.

Therefore, when the material constituting the light guide 13 and the material constituting the light shielding member 14 are different from each other, it is possible to prevent the light shielding member 14 from being peeled off by a change in the environmental temperature due to the difference of the linear expansion coefficient between these materials.

Therefore, the range of selections of the material constituting the light guide 13 and the material constituting the light shielding member 14 becomes wide, and the degree of freedom in design of the sheet switch module 10 becomes high.

In addition, the light shielding member 14 adheres to the surface 25a of the press sheet 25 constituting the sheet switch 20 with the second adhesive material 17 interposed therebetween.

In addition, when the thickness of the light shielding member 14 is represented as α₁, the thickness of the second adhesive material 17 is represented as α₂, and the thickness of the light guide 13 is represented as α₃, the relationship of 0.8α₃≦α₁+α₂≦2α₃ is satisfied.

Therefore, it is possible to completely shield the light between the first region 13A and the second region 13B by the light shielding member 14.

In addition, since the thickness α₁ of the light shielding member 14 does not become excessively large, it is possible to reduce the thickness of the sheet switch module 10.

Furthermore, it is possible to reduce the thickness of the electronic device to which the sheet switch module 10 is applied.

Additionally, since the light shielding member 14 is disposed upright within the through hole 13c of the light guide 13 using the second adhesive material 17, and since the simple structure is adopted, it is possible to manufacture the sheet switch module without being subjected to a complicated process.

In addition, the sheet switch 20 adheres to the light guide 13 via the first adhesive material 15 provided on the back 13a of the sheet-shaped light guide 13, and the gap 18 is provided between the light guide 13 and the sheet switch 20.

Therefore, the light guide 13 and the sheet switch 20 are not in contact with each other.

That is, the back 13a and the surface 13b of the light guide 13 are in contact with an air layer without being in contact with another member made of a resin.

Therefore, when the emission light from the first light source 11 is incident on the first end-face 13e of the first region 13A of the light guide 13, the incident light is reflected between the back 13a and the surface 13b of the light guide 13 and propagates through the inside of the light guide 13, and thus the rate at which the light leaks out from the portion other than the light extraction portion 19 is small.

Therefore, the light incident on the light guide 13 from the first light source 11 is emitted to the outside of the light guide 13, centered on the light extraction portion 19 in the first region 13A.

Therefore, attenuation of the light propagating through the light guide 13 with the propagation is suppressed to a minimum.

Because of this, it is possible to guide the light of an amount sufficient to light up the light extraction portion 19 over the total length of the first region 13A of the light guide 13.

Similarly, when the emission light from the second light source 12 is incident on one end 13f of the second region 13B of the light guide 13, attenuation of the light propagating through the light guide 13 with the propagation is suppressed to a minimum.

Therefore, it is possible to guide the light of an amount sufficient to light up the light extraction portion 19 over the total length of the second region 1313 of the light guide 13.

In addition, conventionally, a reflective member (reflective sheet) is provided in the interface between the light guide and the sheet switch in order to return the light leaking out to the outside of the light guide to the inside of the light guide.

However, according to the present embodiment, since it is not necessary to provide the conventional reflective member, it is possible to considerably reduce the thickness of the sheet switch module 10.

For this reason, it is possible to considerably reduce the thickness of the electronic device to which the sheet switch module 10 is applied.

In addition, since the light extraction portion 19 is formed directly on the surface 13b of the light guide 13, the light guide 13 itself has a function of the operation key.

Therefore, it is not necessary to laminate the operation key on the light guide unlike a conventional manner, and thus it is possible to considerably reduce the thickness of the sheet switch module 10.

Therefore, it is possible to considerably reduce the thickness of the electronic device to which the sheet switch module 10 is applied.

Additionally, in the present embodiment described above, the sheet switch module 10 including the light guide 13 divided into two regions, the U-shaped through hole 13e when seen in a plan view, and the U-shaped light shielding member 14 installed within the through hole 13c is illustrated by example.

However, the sheet switch module according to the present invention is not limited only thereto.

In the sheet switch module according to the present invention, the light guide can be divided into three or more arbitrarily-shaped regions, and the shapes of the through hole provided between each of the regions can be appropriately adjusted in accordance with the shapes of each of the regions.

Similarly, the shape of the light shielding member placed within the through hole can be appropriately adjusted in accordance with the shape of the through hole.

In addition, in the present embodiment, the sheet switch module 10 including the first light source 11 corresponding to the first region 13A and the second light source 12 corresponding to the second region 13B is illustrated by example.

However, the sheet switch module according to the present invention is not limited only thereto.

In the sheet switch module according to the present invention, when the light guide is divided into three or more regions, the light sources corresponding to each of the regions can be respectively provided.

In addition, in the present embodiment, the sheet switch module 10 in which the light extraction portion 19 constituted by the uneven portion 19A is provided on the surface 13b of the light guide 13 is illustrated by example.

However, the sheet switch module according to the present invention is not limited only thereto.

In the sheet switch module according to the present invention, the light extraction portion constituted by the uneven portion may be provided on the back of the light guide, that is, the surface of the light guide facing the sheet switch.

When the light extraction portion is provided on the back of the light guide in the manner, the light extraction portion is not exposed to the upper surface (surface) of the sheet switch module, and thus the light extraction portion is not easily damaged.

As a result, it is possible to constantly maintain the brightness of the light emitted from the light extraction portion.

In addition, in the sheet switch module according to the present invention, a protective film made of a light-transmissive resin may be provided so as to cover the light extraction portion provided on the surface of the light guide by the printing method and the like.

The light extraction portion is scarcely damaged by the protective film.

### Second Embodiment

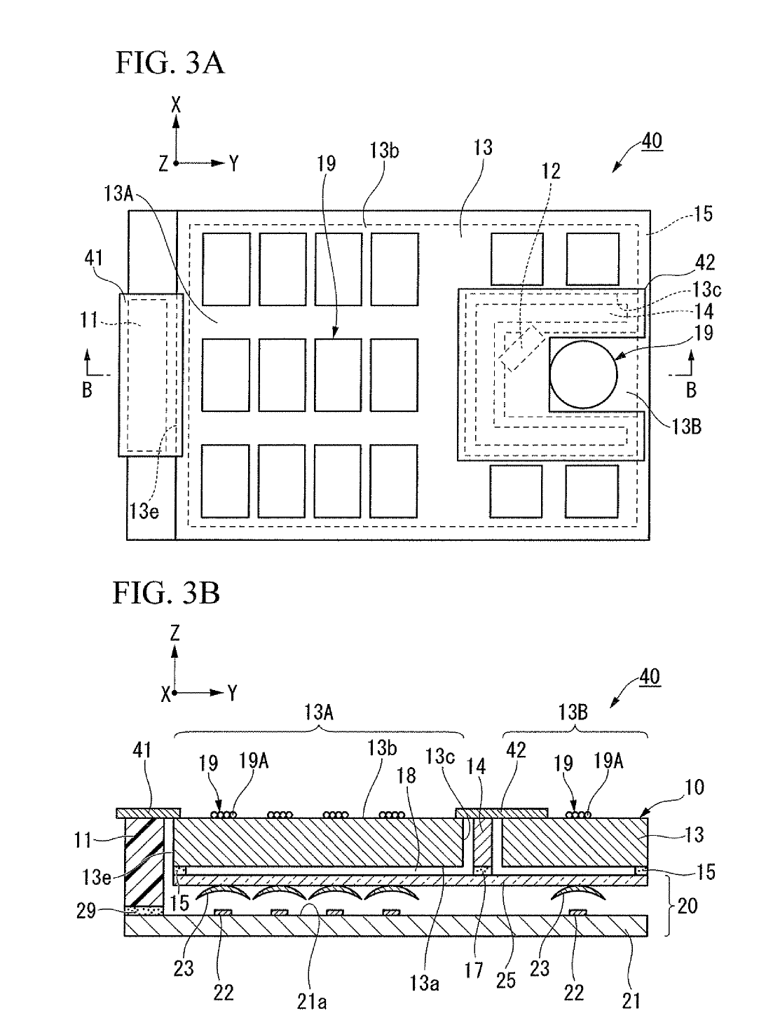

FIG. 3A is a schematic diagram (plan view) showing the sheet switch module according to a second embodiment of the present invention.

FIG. 3B is a cross-sectional view taken along the B-B line of FIG. 3A.

In FIGS. 3A and 3B, the same components as those in the first embodiment shown in FIGS. 1A and 1B are denoted by the same numerals and signs, and the description thereof will be omitted.

The point in which a sheet switch module 40 according to the present embodiment is different from the sheet switch module 10 according to the first embodiment is in that it includes a first light shielding sheet 41 that covers the first light source 11 and its vicinities and a second light shielding sheet 42 that covers the light shielding member 14 and its vicinities.

In more detail, the first light shielding sheet 41 is disposed so as to cover the first light source 11 and the first end-face 13e and its vicinities of the light guide 13 from the surface 13b side of the light guide 13.

In addition, the second light shielding sheet 42 is disposed so as to cover the second light source 12 and the through hole 13c and its opening periphery of the light guide 13 from the surface 13b side of the light guide 13.

The materials constituting the first light shielding sheet 41 and the second light shielding sheet 42 are not particularly limited as long as they are a light shielding material, but for example, the material obtained by coloring one selected from a group consisting of a polyurethane-based resin, a polycarbonate-based resin, a silicon-based resin, a polystyrene-based resin, a polyimide-based resin and the like is used.

The hues of the first light shielding sheet 41 and the second light shielding sheet 42 are not particularly limited as long as the hues have a sufficient light shielding property, but a black color is preferable because it absorbs the light best and has a high light shielding property.

In addition, the thicknesses of the first light shielding sheet 41 and the second light shielding sheet 42 are not particularly limited as long as the thicknesses have a sufficient light shielding property.

The first light shielding sheet 41 that covers the first light source 11 and the first end-face 13e and its vicinities of the light guide 13 is provided in the sheet switch module 40.

Therefore, it is possible to shield the light leaking from the first light source 11 to the upper surface (surface 13b of the light guide 13) side of the sheet switch module 40.

Furthermore, it is possible to reduce the hot spot in which only the first end-face 13e of the light guide 13 adjacent to the first light source 11 is extremely brightened.

In addition, the second light shielding sheet 42 that covers the second light source 12 and the through hole 13e and its opening periphery of the light guide 13 is provided.

Therefore, it is possible to completely shield the light leaking from the gap 16 between the inner periphery 13d of the through hole 13c and the outer periphery 14a of the light shielding member 14.

In more detail, the light which is incident on the first end-face 13e of the light guide 13 from the first light source 11, propagates through the light guide 13, and is emitted from the inner periphery 13d of the through hole 13c can be completely prevented from leaking to the outside of the gap 16.

Therefore, it is possible to light up only a desired region (any of the first region 13A or the second region 13B).

Additionally, in the present embodiment, the sheet switch module 40 provided with the first light shielding sheet 41 that covers the first light source 11 and its vicinities and the second light shielding sheet 42 that covers the light shielding member 14 and its vicinities is illustrated by example.

However, the sheet switch module according to the present invention is not limited only thereto.

The sheet switch module according to the present invention may be provided with only the light shielding sheet that covers the light shielding member and the through hole and its vicinities.

### Third Embodiment

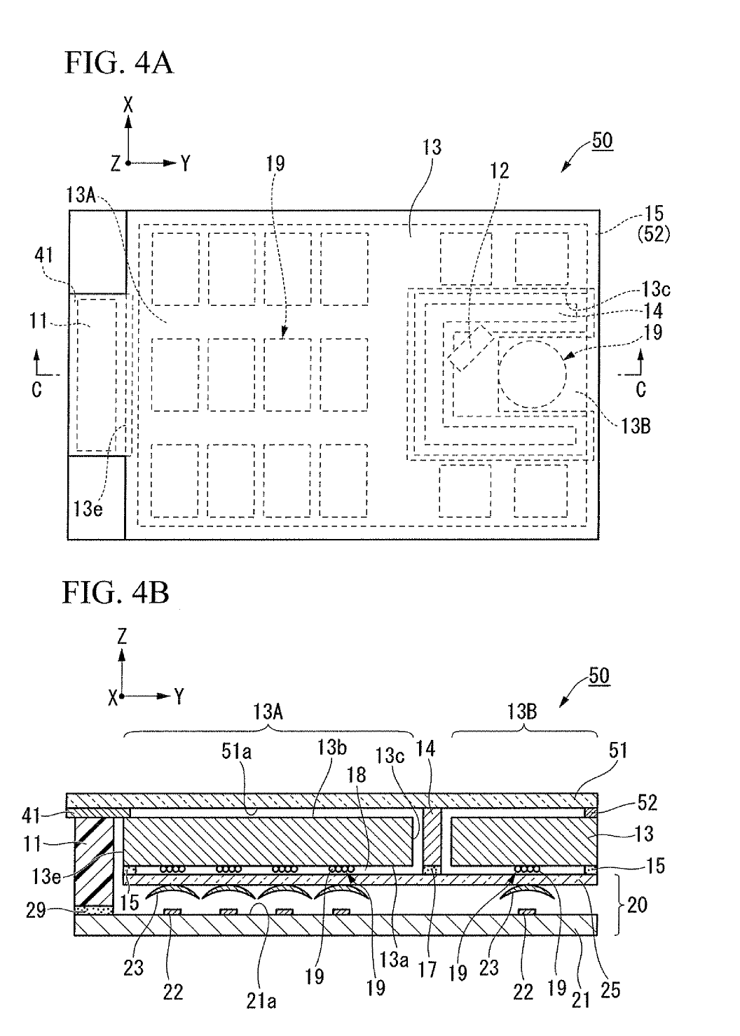

FIG. 4A is a schematic diagram (plan view) showing the sheet switch module according to a third embodiment of the present invention.

FIG. 4B is a cross-sectional view taken along the C-C line of FIG. 4A.

In FIGS. 4A and 4B, the same components as those of the sheet switch module 10 shown in FIGS. 1A and 1B and the sheet switch module 40 shown in FIGS. 3A and 3B are denoted by the same numerals and signs, the description thereof will be omitted.

A sheet switch module 50 according to the present embodiment is different from the sheet switch module 10 according to the first embodiment in the following respect.

That is, the sheet switch module includes the first light shielding sheet 41 that covers the first light source 11 and its vicinities and an operation key 51 placed on the surface 13b (surface on the side opposite to the surface facing the sheet switch 20) side of the light guide 13.

The light shielding member 14 is provided on the back 51a (surface facing the light guide 13) of the operation key 51.

The light shielding member 14 is disposed in the through hole 13c of the light guide 13.

Additionally, the light shielding member 14 adheres to the surface 25a of the press sheet 25 constituting the sheet switch 20 by the second adhesive material 17.

In addition, a plurality of light extraction portions 19 is formed in a predetermined position of the back 13a of the light guide 13.

In addition, a frame-shaped spacer 52 provided in the periphery of the surface 13b of the light guide 13 is provided between the operation key 51 and the surface 13b of the light guide 13.

The width of the spacer 52 is substantially the same as the width of the above-mentioned first adhesive material 15.

Of course, the light extraction portion 19 can be formed on the surface 13b the light guide 13.

Furthermore, an adhesive material may be formed between the operation key 51 and the light shielding member 14.

The operation key 51 is made of a light-transmissive resin. This resin is not particularly limited as long as it is elastically deformable, but for example, one selected from a group consisting of a polyurethane-based resin, a polycarbonate-based resin, a silicon-based resin, a polystyrene-based resin, a polyimide-based resin, elastomer of polymethylmethacrylate (PMMA), and urethane acrylate is used as the resin.

As the spacer 52, the same spacer as that of the first adhesive material 15 and the second adhesive material 17 is used.

The sheet switch module 50 includes the operation key 51 placed on the surface 13b side of the light guide 13, and the light shielding member 14 is provided on the surface (surface facing the light guide 13) 51a of the operation key 51.

The light shielding member 14 is disposed in the through hole 13c of the light guide 13, and the light shielding member 14 adheres to the surface 25a of the press sheet 25 constituting the sheet switch 20 by the second adhesive material 17.

Therefore, it is possible to manufacture the sheet switch module without being subjected to a complicated process.

In other cases, in the sheet switch module according to the present invention, as in the sheet switch module 50, the light shielding member 14 may not adhere to the surface 25a of the press sheet 25 constituting the sheet switch 20 by the second adhesive material 17.

That is, the lower end (end on the side facing the sheet switch) of the light shielding member 14 may be suspended in midair without installing the second adhesive material 17.

In this case, it is more preferable to make the light shielding member 14 a little longer than that of the previous embodiment so that the light does not leak from between the end of the light shielding member 14 and the press sheet 25.

In this way, it is not necessary to fix the light shielding member into the through hole of the light guide using the adhesive material.

Therefore, it is possible to manufacture the sheet switch module without being subjected to a complicated process.

### Fourth Embodiment

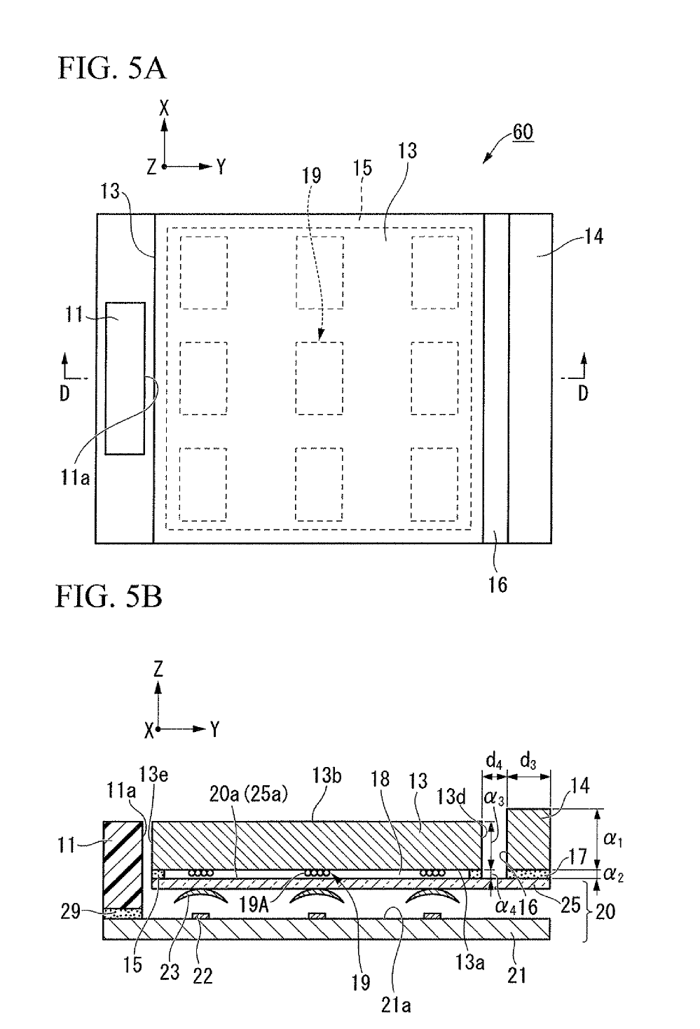

FIG. 5A is a schematic diagram (plan view) showing the sheet switch module according to a fourth embodiment of the present invention.

FIG. 5B is a cross-sectional view taken along the D-D line of FIG. 5A.

In FIGS. 5A and 5B, the same components as those of the sheet switch module 10 shown in FIGS. 1A and 1B and the sheet switch module 40 shown in FIGS. 3A and 313 are denoted by the same numerals and signs, the description thereof will be omitted.

The sheet switch module 50 according to the present embodiment is different from the sheet switch module 10 shown in FIGS. 1A and 1B in the following respect.

The sheet switch module 50 according to the present embodiment includes the light guide 13 constituted by one region, and one light source 11.

In the present embodiment, the light guide 13 is formed in a rectangular shape when seen in a plan view (X-Y plane).

Moreover, the shape and the installation position of the light shielding member 14 according to the present embodiment are different from those in sheet switch module 10.

In the present embodiment, as shown in FIG. 5A, the light shielding member 14 is formed in a rectangular shape corresponding to the shape of the rectangular light guide 13.

Furthermore, in the second end side of the light guide 13, the light shielding member 14 adheres to the surface 20a of the sheet switch 20 through the rectangular second adhesive material 17.

Additionally, the light shielding member 14 is provided away from a second end-face 13d of the light guide 13 in the Y direction.

That is, the gap 16 is provided between the light shielding member 14 and the light guide 13 in the Y direction.

Consequently, the light shielding member 14 faces the second end-face 13d of the light guide 13, and is disposed on the surface 20a of the sheet switch 20 at a distance from the second end-face 13d.

The width d3 of the light shielding member 14 is not particularly limited as long as the light which propagates through the inside of the light guide 13 and is emitted from the second end-face 13d of the light guide 13 can be prevented (shielded) from leaking to the outside of a sheet switch module 60 by the light shielding member 14, but the width is preferably greater than or equal to 0.5 mm, and more preferably 0.5 mm to 0.8 mm.

When the gap 16 is provided between the light shielding member 13 and the light guide 12 in the case where the width d3 of the light shielding member 14 is less than 0.5 mm, it is difficult to perform perforating through the mold.

On the other hand, when the width d3 of the light shielding member 14 exceeds 0.8 mm, it is not preferable because the occupancy ratio of the light shielding member 14 in the sheet switch module 60 becomes excessively large and thus the occupancy ratio of the light guide 13 becomes small, resulting in the reduction in the light-emitting area.

The width d4 of the gap 16 is not particularly limited as long as the light which propagates through the inside of the light guide 13 and is emitted from the second end-face 13d of the light guide 13 can be prevented (shielded) from leaking to the outside of the sheet switch module 60 by the light shielding member 14, but the width is preferably in a range of 0.2 mm<d4<1 mm, and more preferably in a range of 0.2 mm<d4<0.4 mm.

When the light emitted from the second end-face 13d of the light guide 13 spreads in the case where the width d4 of the gap 16 exceeds 1 mm, it is not possible to completely prevent (shield) the light from leaking to the outside of the sheet switch module 60.

In addition, similarly to the first embodiment, when the thickness (height) of the light shielding member 14 in the Z direction is represented as α₁, the thickness (height) of the second adhesive material 17 is represented as α₂, the thickness (height) of the light guide 13 is represented as α₃, and the thickness (height) of the first adhesive material 15 is represented as α₄, the light-shielding effect was measured by changing the thicknesses of the light shielding member 14, the second adhesive material 17, and the light guide 13.

The results are shown in the following Table 7 to Table 9.

In the following test example, the thickness α₂ of the second adhesive material 17 and the thickness α₄ of the first adhesive material 15 are the same as each other.

TABLE 7

| Thickness | | Thickness (α₁) of light shielding member | | | |
|---|---|---|---|---|---|
| 100 μm (α₃) of light guide | | 75 μm | 125 μm | 188 μm | 250 μm |
| Adhesive | 30 μm | G | G | G | G |
| material (α₂) | 60 μm | G | G | G | G |
| | 90 μm | G | G | G | G |

TABLE 8

| Thickness | | Thickness (α₁) of light shielding member | | | |
|---|---|---|---|---|---|
| 150 μm (α₃) of light guide | | 75 μm | 125 μm | 188 μm | 250 μm |
| Adhesive | 30 μm | G | G | G | G |
| material (α₂) | 60 μm | G | G | G | G |
| | 90 μm | G | G | G | G |

TABLE 9

| Thickness | | Thickness (α₁) of light shielding member | | | |
|---|---|---|---|---|---|
| 200 μm (α₃) of light guide | | 75 μm | 125 μm | 188 μm | 250 μm |
| Adhesive | 30 μm | NG | G | G | G |
| material (α₂) | 60 μm | NG | G | G | G |
| | 90 μm | NG | G | G | G |

G: The light-shielding effect is sufficient.
NG: The light-shielding effect is insufficient.
B: There is no light-shielding effect.

As can be seen from the above test example, when the light is prevented from being reflected from the surface of the sheet switch 20 and leaking therefrom, it is preferable that the thickness α₁ of the light shielding member 14 is 50% or more of the thickness α₃ of the light guide 13.

That is, when the light is prevented from leaking due to the surface reflection of the sheet switch 20, it is preferable that the relational expression of 0.5α₃≦α₁ is satisfied.

However, when the light emitted from the second end-face 13d of the light guide 13 is completely blocked, similarly to the example of the whole circumference adhesion in the first embodiment, it is preferable to satisfy the relational expression of α₃≦α₁≦2α₃ (α₂≧0.5α₃) or 0.8α₃≦α₁≦2α₃ (α₂≦0.5α₃).

Furthermore, when the thicknesses of the first adhesive 15 and the second adhesive 17 are different from each other, it is preferable to satisfy the relationship of α₃+α₄≦α₁+α₂≦2α₃, and more preferable to satisfy of the relationship of α₃+α₄<α₁+α₂≦2α₃.

In the relationship of α₁+α₂<α₃+α₄, the light which propagates through the inside of the light guide 13 and is emitted from the second end-face 13d of the light guide 13 cannot be prevented (shielded) from leaking to the outside of the sheet switch module 60 by the light shielding member 14.

On the other hand, in the relationship of α₁+α₂>2α₃, the thickness α₁ of the light shielding member 14 becomes excessively large, and thus it is difficult to reduce the thickness of the sheet switch module 60.

In addition, the thickness α₂ of the second adhesive material 17 is not particularly limited as long as the above-mentioned relationship is satisfied.

Furthermore, the material constituting the light shielding member 14 is not particularly limited as long as it is a light shielding material and has such a rigidity that it can erect the light shielding member at the time of placing the light shielding member 14 on the surface 20a of the sheet switch 20. However, for example, one selected from a group consisting of resins such as a polyurethane-based resin, a polycarbonate-based resin, a silicon-based resin, a polystyrene-based resin, a polyimide-based resin, and a polyester-based resin, and various types of metals is used as the material.

Among these resins, in a sheet switch module manufacturing method described later, a polyurethane-based resin is preferable because a burr does not occur in the processing surface (surface which is in contact with a perforation mold at the time of perforation) of the light shielding member 14 at the time of simultaneously perforating the light guide 13 and the light shielding member 14.

In addition, from the viewpoint of reducing the material costs, a polyester-based resin such as polyethylene terephthalate is preferable.

When the emission light from the light source 11 is incident on the first end-face 13e of the light guide 13, the incident light is reflected between the back 13a and the surface 13b of the light guide 13 and propagates through the inside of the light guide 13.

In addition, since the uneven portion and the like are formed in the required region of the back 13a of the light guide 13, the light propagating through the inside thereof leaks out from the uneven portion.

Accordingly, it is possible to emit the light from the light extraction portion 19 of the light guide 13 to the outside.

That is, it is possible to light up the light extraction portion 19 using the light propagating through the inside of the light guide 13.

According to the sheet switch module 60 of the present embodiment, the light shielding member 14 faces the second end-face 13d of the light guide 13, and is disposed at a distance from the second end-face 13d.

Therefore, when the emission light from the light source 11 is incident on the first end-face 13e of the light guide 13, it is possible to light up only the light extraction portion 19 provided on the back 13a of the light guide 13 using the incident light.

Furthermore, it is possible to prevent (shield) the light which propagates through the inside of the light guide 13 and is emitted from the second end-face 13d of the light guide 13 from leaking to the outside of the sheet switch module 60.

Therefore, it is possible to sufficiently light up the light extraction portion 19 using the light propagating through the inside of the light guide 13.

In addition, when the light shielding member 14 adheres to the surface 25a (surface 20a of the sheet switch 20) of the press sheet 25 constituting the sheet switch 20 with the second adhesive material 17 interposed therebetween, and the thickness of the light shielding member 14 is represented as α₁, the thickness of the second adhesive material 17 is represented as α₂, the thickness of the light guide 13 is represented as α₃, and the thickness of the first adhesive material 15 is represented as α₄, the relationship of α₃+α₄≦α₁+α₂≦α₃ is satisfied.

Additionally, when the thickness α₂ of the second adhesive material 17 and the thickness α₄ of the first adhesive material 15 are the same as each other, the relationship of α₃≦α₁≦2α₃ (α₂≧0.5α₃) or 0.8α₃≦α₁≦2α₃ (α₂≦0.5α₃) is satisfied.

Therefore, it is possible to completely prevent (shield) the light that propagates through the inside of the light guide 13 and is emitted from the second end-face 13d of the light guide 13 from leaking to the outside of the sheet switch module 60 by the light shielding member 14.

In addition, since the thickness α₁ of the light shielding member 14 does not become excessively large, it is possible to reduce the thickness of the sheet switch module 60.

Furthermore, it is possible to reduce the thickness of the electronic device to which the sheet switch module 60 is applied.

In addition, since the light shielding member 14 is disposed upright on the second end side of the light guide 13 using the second adhesive material 17, and since the simple structure is adopted, it is possible to manufacture the sheet switch module without being subjected to a complicated process.

In addition, similarly to the embodiment described above, the sheet switch 20 adheres to the light guide 13 via the first adhesive material 15 provided on the back 12a of the sheet-shaped light guide 13, and the gap 18 is provided between the light guide 13 and the sheet switch 20.

Therefore, the light guide 13 and the sheet switch 20 are in not contact with each other.

That is, the back 13a and the surface 13b of the light guide 13 are in contact with an air layer without being in contact with another member made of a resin.

Therefore, when the emission light from the light source 11 is incident on the first end-face 13e of the light guide 13, the incident light is reflected between the back 13a and the surface 13b of the light guide 13 and propagates through the inside of the light guide 13, and thus the rate at which the light leaks out from the portion other than the light extraction portion 19 is small.

Therefore, the light incident on the light guide 13 from the light source 11 is emitted to the outside of the light guide 13 centered on the light extraction portion 19.

Therefore, attenuation of the light propagating through the light guide 13 with the propagation is suppressed to a minimum.

Because of this, it is possible to guide the light of an amount sufficient to light up the light extraction portion 19 over the total length of the light guide 13.

Additionally, in the present embodiment, the sheet switch module 60 in which the light extraction portion 19 constituted by the uneven portion 19A is provided on the back 13a of the light guide 13 is illustrated by example.

However, the sheet switch module according to the present invention is not limited thereto.

In the sheet switch module according to the present invention, the light extraction portion constituted by the uneven portion may be provided on the surface of the light guide, that is, the surface on the side opposite to the surface of the light guide facing the sheet switch.

In other cases, in the present embodiment, similarly to the second embodiment, it is possible to install the light shielding sheet that covers the light shielding member 14 and its surroundings.

Furthermore, similarly to the third embodiment, it is possible to install the operation key 51, and to install the light shielding member 14 in the operation key 51.

<<Method of Manufacturing Sheet Switch Module>>

Next, a method of manufacturing the sheet switch module according to a fourth embodiment of the present invention will be described with reference to the drawings.

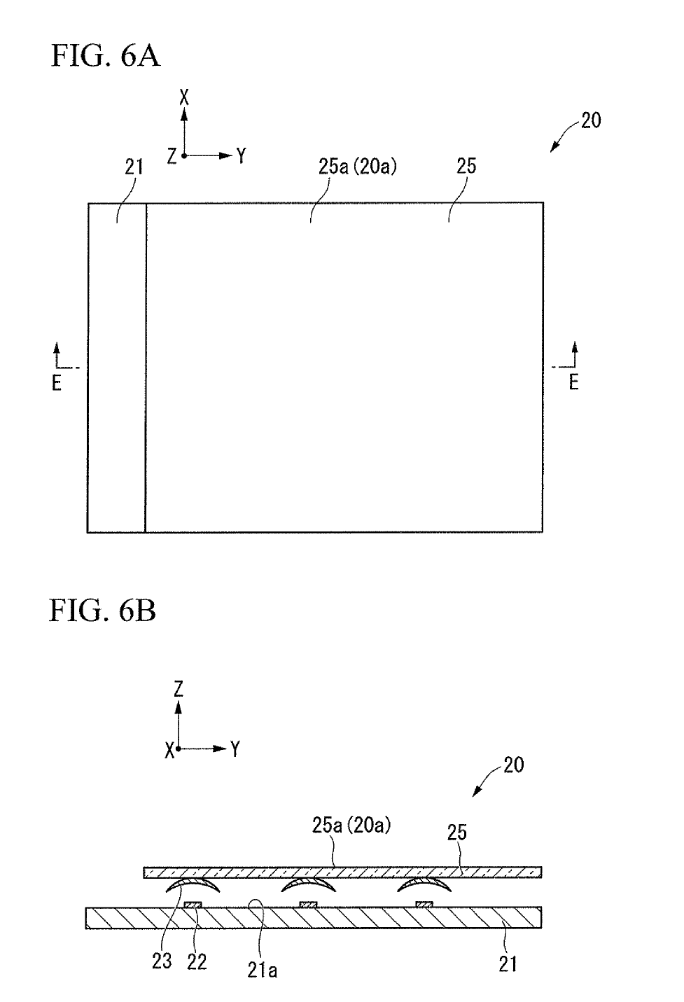

First, as shown in FIGS. 6A and 6B, the sheet switch 20 including the board 21, the contact portion 22, the metal plate 23, and the press sheet 25 is produced.

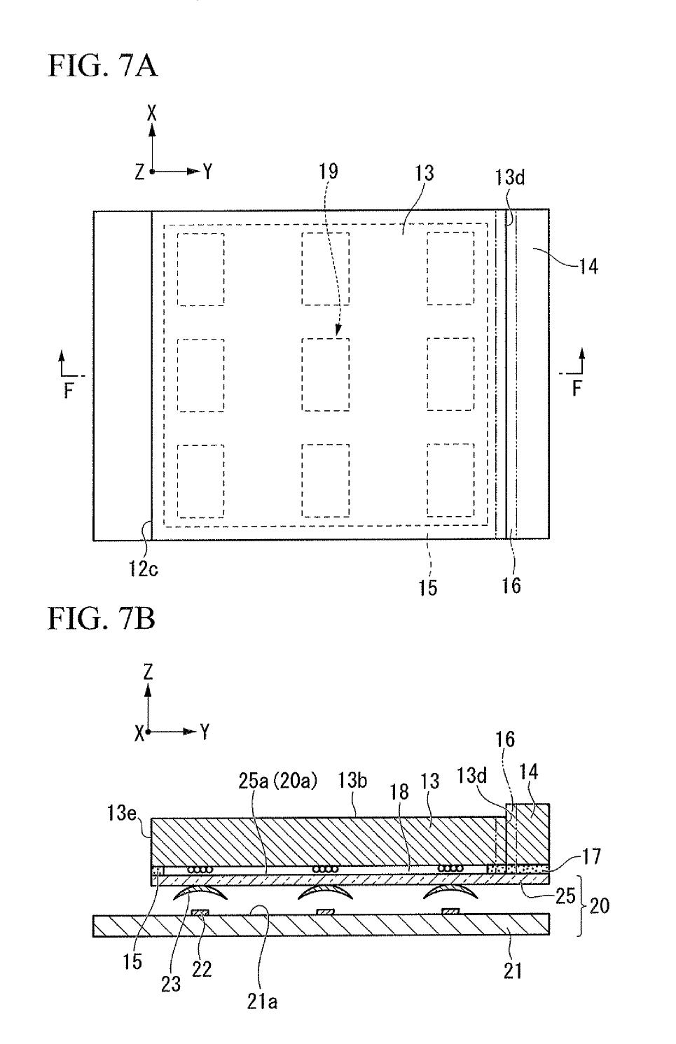

Next, as shown in FIGS. 7A and 7B, the light guide 13 is caused to adhere to the surface 25a (surface 20a of the sheet switch 20) of the press sheet 25 constituting the sheet switch 20 with the first adhesive material 15 interposed therebetween.

A light extraction portion 18 is formed on the back 13a of the light guide 13.

Next, as shown in FIG. 7B, the light shielding member 14 is caused to adhere to the surface 25a of the press sheet 25 with the second adhesive material 17 interposed therebetween.

At the time of adhesion of the light shielding member 14, as shown in FIG. 7B, the end-face of the light shielding member 14 is brought into contact with the second end-face 13d of the light guide 13.

Next, after the light guide 13 and the light shielding member 14 which are provided on the surface 25a of the press sheet 25 are simultaneously perforated using a mold and the like, a part of the portion in which the light guide 13 and the light shielding member 14 are in contact with each other is removed, and the gap 16 is formed between the light guide 13 and the light shielding member 14.

In this process, the portion in which the light guide 13 and the light shielding member 14 are in contact with each other is perforated in the X direction and the Z direction of the drawing.

That is, the perforation thereof is performed in the direction (X direction) perpendicular to the longitudinal direction of the light guide 13 and the thickness direction (Z direction) of the light guide 13 and the light shielding member 14.

At this time, the first adhesive material 15 and the second adhesive material 17 are simultaneously perforated and then removed.

Next, in one end (first end side of the light guide 13) of the base 21 constituting the sheet switch 20, the light source 11 is provided on the surface 21a with the solder 29 interposed therebetween, to thereby obtain the sheet switch module 60.

In this process, the light source 11 is disposed so that the emission surface 11a of the light source 11 and the first end-face 13e of the light guide 13 are close to each other at a predetermined distance.

According to the method of manufacturing the sheet switch module, since the light guide 13 and the light shielding member 14 which are provided on the surface 25a of the press sheet 25 are simultaneously perforated, the width d4 of the gap 16 can be 0.2 mm<d4<0.4 mm.

Therefore, since the width of the light shielding member 14 can be reduced insofar as possible, it is possible to increase the degree of freedom in design of the sheet switch module.

In addition, when a polyurethane-based resin is used as the material constituting the light shielding member 14, a burr does not occur in the processing surface (surface which is in contact with a perforation mold at the time of perforation) of the light shielding member 14 at the time of simultaneously perforating the light guide 13 and the light shielding member 14, and thus it is possible to smoothly process the processing surface of the light shielding member 14.

As a result, it is possible to prevent the light emitted from the second end-face 13d of the light guide 13 from being scattered in the processing surface (surface of the light guide 13 facing the second end-face 13d) of the light shielding member 14.

The sheet switch module according to the present invention can be widely applied to an illumination device which selectively lights up (or does not light up) only a specific operation key.

Furthermore, the sheet switch module according to the present invention can be widely applied to an illumination device capable of sufficiently preventing light from leaking to the outside.

What is claimed is:

1. A sheet switch module comprising:
a light source;
a light guide having a first end-face on which light emitted from the light source is incident, the light guide guiding the light in at least the thickness direction thereof;
a sheet switch disposed on the back side of the light guide in the thickness direction of the light guide; and
a light shielding member disposed at a distance from a second end-face different from the first end-face of the light guide.

2. The sheet switch module according to claim 1, wherein
the light guide includes a plurality of regions divided by a through hole penetrating therethrough in the thickness direction, and
the light shielding member is disposed in the through hole at a distance from the end-face of the light guide formed by the through hole.

3. The sheet switch module according to claim 1, wherein
the distance is 0.2 mm to 1 mm.

4. The sheet switch module according to claim 2, wherein
the distance is 0.2 mm to 1 mm.

5. The sheet switch module according to claim 2, wherein
the light shielding member is attached to the surface of the sheet switch with a second adhesive material interposed therebetween, and
when the thickness of the light shielding member is represented as α₁, the thickness of the second adhesive material is represented as α₂, and the thickness of the light guide is represented as α₃, the following relational expression (1) is satisfied:
0.8α₃−α₂≦α₁≦2α₃−α₂ (1).

6. The sheet switch module according to claim 2, wherein
the light shielding member is attached to the surface of the sheet switch with an adhesive material interposed therebetween,
the regions of the light guide are attached to the surface of the sheet switch with the adhesive material interposed therebetween, and
when the thickness of the light shielding member is represented as α₁, the thickness of the adhesive material is represented as α₂, and the thickness of the light guide is represented as α₃, the following relational expression (2) or (3) is satisfied:
α₃≦α₁≦2α₃(α₂≧0.5α₃) (2)
0.8α₃≦α₁≦2α₃(α₂≦0.5α₃) (3).

7. The sheet switch module according to claim 2, wherein
the through hole is a U-shaped through hole, and
the light source is placed in each region of the light guide.

8. The sheet switch module according to claim 1, wherein
the light guide is attached to the surface of the sheet switch with a first adhesive material interposed therebetween,
the light shielding member is attached to the surface of the sheet switch with a second adhesive material interposed therebetween, and
when the thickness of the light shielding member is represented as α₁, the thickness of the second adhesive material is represented as α₂, the thickness of the light guide is represented as α₃, and the thickness of the first adhesive material is represented as α₄, any one of the following relational expressions (4), (5), and (6) is satisfied:
α₃≦α₁≦2α₃(α₂≧0.5α₃; α₂=α₄) (4)
0.8α₃≦α₁≦2α₃(α₂≦0.5α₃; α₂=α₄) (5), and
α₃+α₄≦α₁+α₂≦α₃(α₂≠α₄) (6).

9. The sheet switch module according to claim 1, further comprising
a light shielding sheet that covers at least the light shielding member and the through hole.

10. The sheet switch module according to claim 2, further comprising
a light shielding sheet that covers at least the light shielding member and the through hole.

11. The sheet switch module according to claim 1, further comprising
an operation key disposed on the surface side of the light guide in the thickness direction of the light guide, wherein
the light shielding member is provided on the surface of the operation key facing the light guide.

12. The sheet switch module according to claim 2, further comprising
an operation key disposed on the surface side of the light guide in the thickness direction of the light guide, wherein
the light shielding member is provided on the surface of the operation key facing the light guide.

13. A sheet switch module manufacturing method, comprising:
attaching a light guide and a light shielding member on the surface of a sheet switch with an adhesive material interposed therebetween; and
simultaneously perforating the light guide and the light shielding member in the thickness direction of the light guide, thereby forming a gap between the light guide and the light shielding member.

14. The sheet switch module manufacturing method according to claim 10, wherein
the attachment step includes attaching the light guide to the surface of the sheet switch with a first adhesive material interposed therebetween, and
attaching the light shielding member to the surface of the sheet switch with a second adhesive material interposed therebetween.
